(19) United States
(12) Patent Application Publication
(10) Pub. No.: US 2013/0282604 A1
(43) Pub. Date: Oct. 24, 2013

(54) Adaptive collaboration platform and method for enabling forward and backward linkages between business entities

(71) Applicants: ANAND RAVISHANKAR SHUKLA, AMRAVATHI (IN); SIVA PRASAD DEVIREDDY, BANGALORE (IN)

(72) Inventors: ANAND RAVISHANKAR SHUKLA, AMRAVATHI (IN); SIVA PRASAD DEVIREDDY, BANGALORE (IN)

(21) Appl. No.: 13/868,469

(22) Filed: Apr. 23, 2013

(30) Foreign Application Priority Data
Apr. 24, 2012 (IN) 1625/CHE/2012

(51) Int. Cl. G06Q 50/00

(52) U.S. Cl. CPC G06Q 50/01; G06Q 10/101
USPC 705/319

(57) ABSTRACT

A method for suggesting to a first business entity to connect with a second business entity on a network of business entities. The method includes (i) obtaining a first industry type of the first business entity from a profile information of the first business entity, (ii) automatically identifying a second industry type based on (a) the first industry type, and (b) a predefined industry linkage, (iii) automatically identifying the second business entity associated with the second industry type, and (iv) displaying a suggestion to the first business entity to connect with the second business entity.

### CROSS-REFERENCE TO RELATED APPLICATIONS

This application claims priority to Indian patent application no. 1625/CHE/2012 filed on Apr. 24, 2012, the complete disclosure of which, in its entirely, is herein incorporated by reference.

### BACKGROUND

1. Technical Field

The embodiments herein generally relate to a network of business entities and, more particularly, a system and method for enabling forward and backward linkages among business entities.

2. Description of the Related Art

A business entity is an institution formed to engage in business activities such as the sale or trading of products or services, both for profit, as well as non-profit. Business entities include organizations such as corporations, partnerships, sole proprietorships, sole traders, cooperatives, limited liability companies, charities, trusts, etc. Business entities often engage with other business entities for commercial transactions via a business model called Business-to-business (B2B), which is in contrast to business-to-consumer (B2C). One example of a B2B transaction is between a manufacturer and a wholesaler, and another is between a wholesaler and a retailer.

The volume of B2B (Business-to-Business) transactions is much higher than the volume of B2C transactions. The primary reason for this is that in a typical supply chain there will be many B2B transactions involving sub components or raw materials, and only one B2C transaction, specifically sale of the finished product to the end customer. Many businesses use social media to connect with their consumers (B2C). In addition, some businesses are now using similar tools within the business so that employees or members can connect with one another. However, these social media do not adequately address the challenge of B2B communication and collaboration.

Social media are used to build social networks or social relations among people who, for example, share interests, business activities, and professional connections. Individual that are connected with other individuals on social media will get updates about the connections and other activities of these other individuals. These social media are typically individual centered for connecting an individual with another individual, such as for job searching or consulting assignments. Criteria for connecting an individual with another are different from criteria for connecting a business entity with another, since the complexity as well as volume of business transactions between business entities (B2B) is higher as compared to between individuals.

Business entities may identify other business entities for collaboration through listings or directories. In order to identify a suitable business entity for collaboration, one would have to either serially browse listings by category, or perform a keyword based manual search. The approaches of browsing listings or keyword based manual searches are tedious, cumbersome and time consuming, and it is not easy to identify a relevant business entity using these approaches. Further, if a business entity is not clearly aware of the types of business entities or categories that are suitable for collaboration, it would be unable to discover or identify such complementary business entities.

A cooperative (e.g., also called a co-operative or a co-op) is an autonomous association of persons who voluntarily cooperate for their mutual social, economic, and cultural benefit. It cooperative is a form of a business entity owned and managed by its members in which members with limited resources can join together and collectively strive to achieve their economic goals. The co-operatives have over a billion members worldwide across major industries including agriculture, dairy, sugar, fisheries, handicrafts, handlooms and retail. As economic enterprises and self-help organizations, they play a significant role in sustainable economic development and integration of their members and the local community Cooperatives exist in multiple sectors today and may be classified as “Producers”, “Industrial”, “Service”, and “Consumer” cooperative types. There are well defined supply chains existing across these cooperative sectors. These value chains are mostly undiscovered by cooperatives today. Collaboration, business partnerships, buying and selling products or services, sharing knowledge and resources etc. are a challenge for any type of business entity in today's global economy, including for cooperatives. These challenges are particularly significant for collaboration across various geographies around the world and across different market segments, the value chains are mostly undiscovered by the business entities of today, due to a lack of awareness on how to discover synergies for collaboration with other businesses. Accordingly, there remains a need for discovering synergies and enabling better collaboration among business entities.

### SUMMARY

In view of the foregoing, an embodiment herein provides a method for suggesting to a first business entity to connect with a second business entity on a network of business entities. The method include (i) obtaining a first industry type of the first business entity from a profile information of the first business entity, (ii) automatically identifying a second industry type based on (a) the first industry type, and (b) a predefined industry linkage, (iii) automatically identifying the second business entity associated with the second industry type, and (iv) displaying a suggestion to the first business entity to connect with the second business entity.

The predefined industry linkage may include a forward linkage or a backward linkage between the first industry type and the second industry type. The method may further include automatically identifying a third industry type based on the predefined industry linkage. The method may further include (a) automatically obtaining a buying interest of the first business entity based on the profile information of the first business entity, and (b) identifying a third business entity associated with a matching selling interest that matches with the buying interest of the first business entity. The method may further include (a) automatically obtaining a selling interest of the first business entity based on the profile information of the first business entity, and (b) identifying a fourth business entity associated with a matching buying interest that matches with the selling interest of the first business entity. The method may further include collaborating among the first business entity and the second business entity on the network of business entities. The method may further include sharing updates on the first business entity with the second business entity on the network of business entities. The updates may include one or more (i) a business activity, (ii) a business promotion, (iii) a buying requirement and (iv) a general information update. The method may further include identifying one or more (a) an industrial connecting trend across business entities that are associated with the first industry type of the first business entity, (b) a geographical connecting trend across business entities that are located at a geography of the first business entity, and (c) a trade connection trend among geographies. The trade connection among the geographies may be obtained based on market statistics.

In another embodiment, a system for enabling connections among business entities is provided. The system includes (a) a memory unit that stores (i) a set of modules, and (ii) a database; (b) a display unit; (c) a processor that executes the set of modules. The set of modules include: (i) an industry type obtaining module, executed by the processor, that obtains a first industry type of a first business entity from a profile information of the first business entity, (ii) an industrial connecting trend module, executed by the processor, that obtains an industrial connecting trend across business entities that are associated with the first industry type of the first business entity, (iii) a geographical connecting trend module, executed by the processor, that obtains a geographical connecting trend across business entities that are located at a geography of the first business entity, (iv) a trade connection trend module, executed by the processor, that identifies a trade connection trend among geographies. The trade connection trend among geographies is obtained based on market statistics, and (v) a connections suggestion module, executed by the processor, that suggests to the first business entity to connect with the second business entity based on (a) the industrial connecting trend, (b) the geographical connecting trend, and (c) the trade connection trend.

The industry type obtaining module, executed by the processor, that identifies one or more: (a) a second industry type based on one or more (i) the first industry type, and (ii) a predefined industry linkage, and (b) a third industry type based on the predefined industry linkage. The predefined industry linkage may include a forward linkage or a backward linkage between the first industry type and the second industry type. A buying interest of the first business entity is automatically obtained based on the profile information of the first business entity. A third business entity associated with a matching selling interest is identified that matches with the buying interest of the first business entity. A selling interest of the first business entity is automatically obtained based on the profile information of the first business entity. A fourth business entity associated with a matching buying interest is identified that matches with the selling interest of the first business entity. The system may further include an updates sharing module, executed by the processor, which share updates on the first business entity with the second business entity. The updates may include one or more (i) a business activity, (ii) a business promotion, (iii) a buying requirement and (iv) a general information update.

In yet another embodiment, a method for suggesting to a first business entity to connect with a second business entity on a network of business entities. The method include (i) obtaining a first industry type of the first business entity from a profile information of the first business entity, (ii) obtaining a buying interest and a selling interest of the first business entity from a profile information of the first business entity, (iii) obtaining an industrial connecting trend across business entities that are associated with the first industry type of the first business entity, (iv) obtaining a geographical connecting trend across business entities that are located at a geography of the first business entity, (v) obtaining a trade connections trend among geographies across business entities that are associated with the first business entity, (vi) automatically identifying a second industry type based on (a) the first industry type, (b) a predefined industry linkage, (c) the industrial connecting trends, (d) the geographical connecting trends, and (e) the trade connections trend, (vii) automatically identifying the second business entity associated with the second industry type, (viii) identifying a third business entity associated with a matching selling interest that matches with the buying interest of the first business entity, (ix) identifying a fourth business entity associated with a matching buying interest that matches with the selling interest of the first business entity, (x) displaying a suggestion to the first business entity to connect with the second business entity. The trade connections trend may be obtained based on market statistics. The predefined industry linkage may include a forward linkage or a backward linkage between the first industry type and the second industry type. The method may further include automatically identifying a third industry type based on the predefined industry linkage. The method may further include sharing updates among the first business entity and the second business entity on the network of business entities. The updates may include one or more (i) a business activity, (ii) a business promotion, (iii) a buying requirement and (iv) a general information update.

### BRIEF DESCRIPTION OF THE DRAWINGS

The embodiments herein will be better understood from the following detailed description with reference to the drawings, in which:

FIG. 1 illustrates a system view of a first business entity communicating with a second business entity connected through an adaptive collaboration system according to an embodiment herein;

FIG. 2 illustrates an exploded view of the adaptive collaboration system of FIG. 1 according to an embodiment herein;

FIG. 3A is a table view of the connections suggestion module of FIG. 2 illustrating a predefined market linkage in textile sectors according to an embodiment herein;

FIG. 3B is a flow diagram illustrates industry category based suggesting connection among business entities of according to an embodiment herein;

FIG. 4A is a table view of the connections suggestion module of FIG. 2 illustrating one or more suggested connections among business entities based on product category according to an embodiment herein;

FIG. 4B is a flow diagram illustrates product category based suggesting connection among business entities according to an embodiment herein;

FIG. 5 is a flow diagram illustrates analytics based suggesting connection among business entities according to an embodiment herein;

FIG. 6 is a flow diagram illustrates a method of suggesting connections among business entities according to an embodiment herein;

FIG. 7A is a user interface view of the adaptive collaboration system of FIG. 1 illustrating suggesting connections among business entities according to an embodiment herein;

FIG. 7B is a user interface view of adaptive collaboration system of FIG. 1 illustrating sharing updates among business entities according to an embodiment herein;

FIG. 8 is a flow diagram illustrates a method of suggesting connections among business entities on a network of business entities according to an embodiment herein;

FIG. 9 illustrates an exploded view of a personal communication device according to the embodiments herein; and

FIG. 10 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

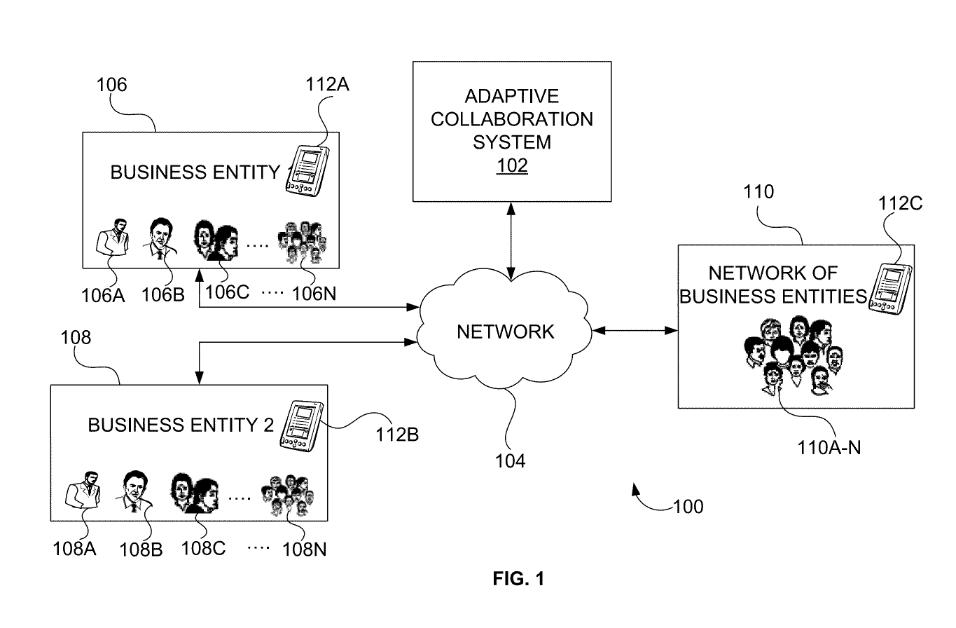

As mentioned, there remains a need for discovering synergies and enabling better collaboration among business entities. The embodiments herein achieve this by providing a business entity connection framework system to enable collaboration among the business entities. An adaptive collaboration system provides a system and method for forward and backward linkages among business entities on a network of business entities. Referring now to the drawings, and more particularly to FIGS. 1 through 10, where similar reference characters denote corresponding features consistently throughout the figures, there are shown preferred embodiments.

FIG. 1 illustrates a system view of a first business entity 106 communicating with a second business entity 108 connected through an adaptive collaboration system 102 according to an embodiment herein. The system view 100 includes the adaptive collaboration system 102, one or more members 106A-N of the first business entity 106, one or more members 108A-N of the second business entity 108, and one or more members 110A-N of a network of business entities 110.

The adaptive collaboration system 102 provides a platform for suggesting to the first business entity 106 to connect with the second business entity 108 on the network of business entities 110. The adaptive collaboration system 102 facilitates to communicate, collaborate and cooperate among other connected business entities. The adaptive collaboration system 102 suggest the first business entity 106 to connect with the second business entity 108 based on (a) an industry category, (b) a product category, and (c) a self-learning mechanism. The adaptive collaboration system 102 can be connected with the first business entity 106 and the second business entity 108 through a network 104. In another embodiment, the network may be an internet, or a broadcast network. In one embodiment, the network of business entities may be e.g., corporations, partnerships, sole proprietorship, cooperatives, charities, trusts, and other forms of organization/entities.

For example, the first business entity 106 may share updates among associated one or more members 106A-N, and other connected network of business entities 110. In one embodiment, the connected network of business entities may be a buyer or a manufacturer (e.g., the one or more buyers) and a connected supplier (e.g., the one or more suppliers). The adaptive collaboration system 102 enables collaboration among the first business entity 106 and the second business entity 108 on the network of business entities. In one embodiment, the collaboration may include (i) reviewing and approving a connection requests, (c) sharing a updates with the connected network of business entities, (d) receiving and displaying the updates from the connected first business entity 106 and the second business entity 108, and (e) posting a response to an update from the connections. For example the updates may include (i) a business activity, (ii) a business promotion, (iii) a buying requirement and (iv) a general information update. In one embodiment, the adaptive collaboration system 102 may reside in a personal communication device 112A-N. For example, the personal communication device 112A-N may be a mobile communication device, a smart phone, a tablet PC, a laptop, a desktop, and an ultra-book etc. In one embodiment, information may be stored in a database and the database may reside in the adaptive collaboration system 102 or in a remote server. In one embodiment, the adaptive collaboration system 102 enables collaboration between (i) cooperatives and business entities (e.g., buyers and/or suppliers), (ii) cooperatives and members of the cooperatives, and/or (iii) cooperatives and other connected cooperatives.

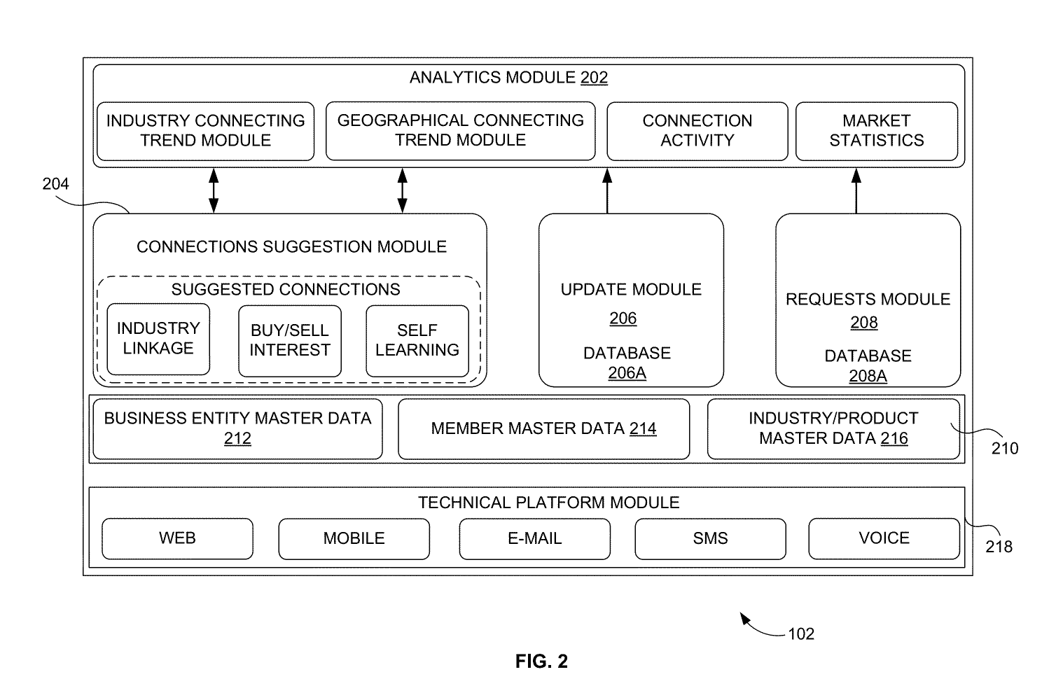

FIG. 2 illustrates an exploded view of the adaptive collaboration system 102 of FIG. 1 according to an embodiment herein. The adaptive collaboration system 102 includes an analytics module 202, a connections suggestion module 204, an update module 206, a requests module 208, a master data module 212, and a technical platform module 218. The analytics module which includes an industry type obtaining module that obtains an industry type of a first business entity from profile information of the first business entity. The analytics module 202 which includes an industry connecting trend module that obtains an industrial connecting trend across business entities that are associated with the industry type of the first business entity. The analytics module 202 which include a geographical connecting trend module that obtains a geographical connecting trend across business entities that are located at geography of the first business entity.

The analytics module 202 which include a trade connection trend module that identifies a trade connection trend among geographies. In one embodiment, the trade connection trend among geographies is obtained based on market statistics. In one embodiment, the analytics module 202 analyses the connection activities and the market statistics based on collected information (e.g., business entities information, one or more buyers/suppliers information, information associated with one or more members of the network of business entities 110, and information associated with one or more industries, products and manufacturer information. In one embodiment, the analytics module 202 analyzes the possible trade connection among various geographies with source of information such as production, consumption, exports and imports of various countries. The analytics module 202 further identifies new connections among business entities belonging to various industries. For example, recent industrial trends may include such as (a) handloom entities that are connected with consumer cooperatives, (b) sugar cooperatives that are connected food processing entities and (c) farming cooperatives that are connected with marketing entities. Connection trends based on the geographical locations may include (a) one or more food processing cooperatives in India connected with one or more sugar production entities in Brazil, (b) coal producers of Indonesia connected with power generation cooperatives of United States of America (USA). The connections suggestion module 204 may suggest all food processing cooperative in India to connect with sugar cooperatives in Brazil as probable suppliers. Similarly, the connections suggestion module 204 may suggest coal producers in Indonesia as probable suppliers to power generation cooperatives of USA.

The connections suggestion module 204 suggests one or more connections among the network of business entities 110 based on industry linkage, buying and selling interests, macro-economic indicators, and self-learning mechanism. In one embodiment, the connections suggestion module 204 suggests all handloom entities with consumer cooperatives as probable buyer connections, and sugar cooperatives and food processing entities as probable supplier connections. Similarly, for farming cooperatives, the connections suggestion module 204 suggests marketing entities as a buyer connection based on these trends identified by the analytics module 202.

Based on these analyses, the connections suggestion module 204 suggests one or more connections to one or more business entities. For example, for trade connection trends, USA has excess production of cotton and it plans for export cotton based on analysis report. Similarly, China has production of cotton shorter than its consumption, so it plans to import. Based on this analysis report, the connections suggestion module 204 suggests all cotton growers and/or marketers in USA as suppliers to connect business entities of China. In one embodiment, a macro-economic indicators module evaluate possible business opportunities among business entities from different geographies based on a data related to economic scenarios prevailing in various geographies which are obtained by the analytics module 202. For example, in case of sugar, produced in excess of domestic consumption in India and Brazil. However in US, the domestic consumption is higher than production, so they have to import sugar from exporting countries. In one embodiment, the macro-economic indicators module may identify the business opportunity based on the market statistics. The macro-economic indicators module may identify the business opportunity based on the data and promote connection among business entities producing sugar in India and Brazil and business entities in US in retail/consumer sector.

Further, the connections suggestion module 204 manages all the connections among the network of business entities 110. In one embodiment, the connections suggestion module 204 may suggests connections based on the search functionality (a) industry, (b) a buyer, (c) a seller, (d) geography and (e) a product category. In one embodiment, the connections suggestion module 204 may assign default categories of connections for cooperatives and other business entities. For example, the default categories of connections according to geographic locations for cooperatives may be (i) suppliers, (ii) buyers, (iii) connected cooperatives and (iv) one or more members of the cooperatives. The default categories of connections for other users may be (i) supplier business entity (ii) buyer or manufacturer business entity (iii) other connected business entity. For example, when a user sends a connection request, it may assign a category to its new connections and similarly while approving an incoming connection request users may be asked for assigning a category to new connection. In another embodiment, custom categories of connections may be assigned as per requirement.

The search module includes a database. The search module enables to search for the other business entities and business partners using one or more key words from the database. In one embodiment, the database may reside in a remote server. In one embodiment, the search module allows users to search one or more prospective connections based on industry type, product category and geography locations.

The update module 206 enables one or more business entities on the network of business entities 110 to create an update (e.g., text, video, voice, etc.) and share across all their connected business entities, other business entities. The update module 206 includes a database 206A that stores the update information (e.g., the text, video, voice, etc.). These updates may be sent to all the connections and the responses can be updated and stored in the database 206A by the update module 206. In one embodiment, these updates may be sent to targeted specific groups of connections. In another embodiment, these updates may be shared with targeted specific groups of connections (e.g., through the adaptive collaboration system 102). Specific updates may be subscribed (e.g., prices and/or promotions) from other business entities.

The updates may be general updates, a business activities, news, buying Leads, offers, discounts, and/or promotions. The updates module 206 enables the one or more business entities and other business partners to receive the updates that are shared and also allows to be viewed through one generic view for all incoming updates. For example, the updates may be segregated according to one or more categories of connections who have initiated it. The member updates may be delivered to members in form of short messaging service (SMS) or E-mails. In one embodiment, the member cooperative may access to online portal for the member updates. The updates module 206 enables the connected business entities to respond back for the updates. In one embodiment, these responses may be stored and viewed by all the connected entities in the database 206A.

The request module 208 provides real-time response capabilities to specific requests (e.g., order status or support requests) raised by one or more business entity members 106A-N of the first business entity or other business entities. The request module 208 includes a database 208A that stores and manages one or more requests. The master data module 210 collects data and stores in a database for processing and managing the connections (e.g., connections activity, market statistics, and buyer/seller interests), collaboration and cooperation among the first business entity 106 and the second business entity 108 on the network of business entities 110. The master data module 210 maintains the collected master data of one or more business entities, a buyer, supplier, industry, and other business partner in the database. The master data module 210 includes a business entity master data 212 that includes (a) a business entity type (e.g. a buyer, a supplier, producer, marketing, consumer etc.), (b) an industry type, (c) parent cooperative (if a cooperative is member of any other cooperative), (d) buying interests (specifying the products categories), (e) selling interests (specifying the products categories), and (f) other generic master data.

In one embodiment, a master data may be collected and validated in the process of registration of a business entity with the adaptive collaboration system 102. The business entity may be provided with access to maintain and update the master data through the database. In one embodiment, the adaptive collaboration system 102 may be a web-based multiple tier architecture based on Drupal Content Management System. The master data module 210 further includes a buyer/supplier master data that stores information about buyer and supplier in the database. The master data module 210 includes a member master data 214 in which the member records are created and updated by the first business entity 106 and the second business entity 108. The member master data 214 may include member ID, name, age, gender, address, contact information, e-mail address, and/or cooperative ID. The master data module 210 includes an industry/product master data 216 that maintains data associated with supplier industries, buyer industries. The list of suggested suppliers and buyer industries for each of the industry may be created by the first business entity 106 and the second business entity 108 based on the value or supply chain logic for each of the industry vertical. For example, spinning industries may procure raw cotton from the ginning industries and sell the yarn to textile industries for producing fabric. Here, the spinning industry may have the buyer industries as textile and supplier industry as ginning industries. The technical platform module 216 allows sending and sharing the updates to members and other connected business entities (e.g., short messaging service, e-mail service, voice messages, web and mobile-based application).

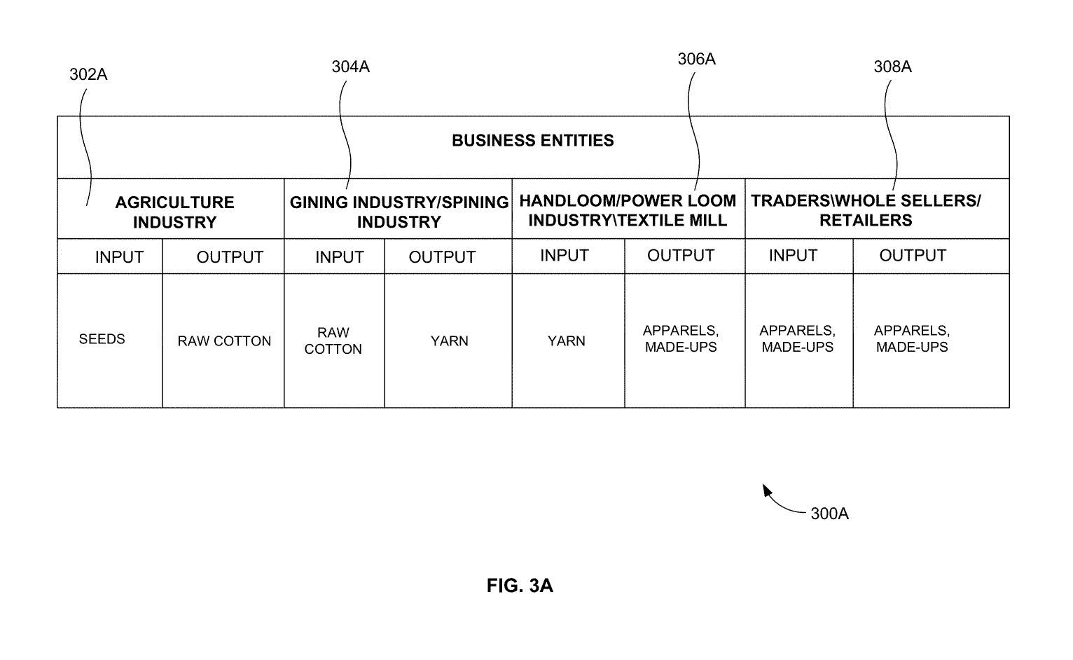

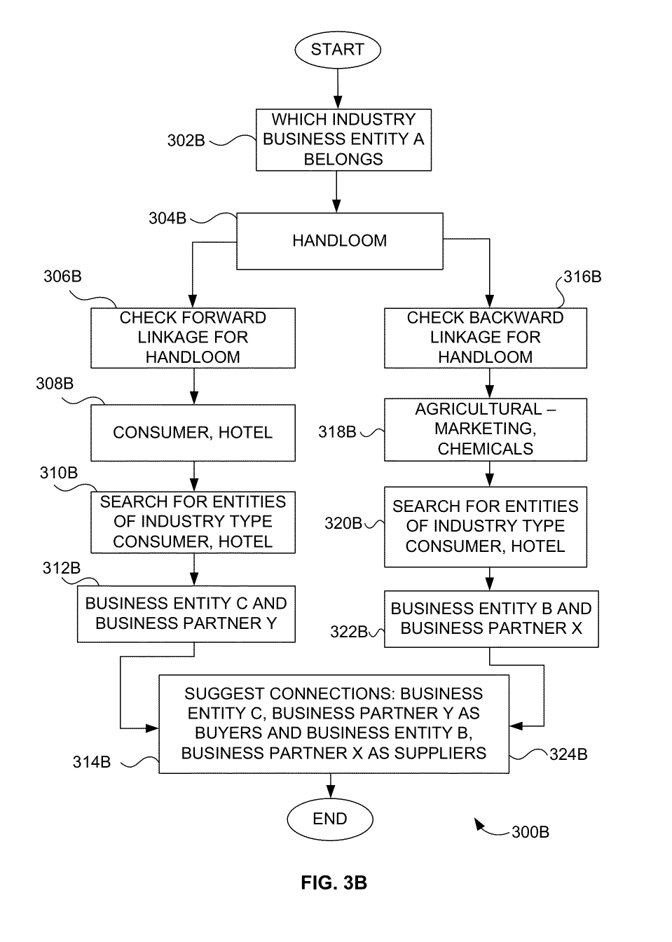

FIG. 3A is a table view of the connections suggestion module 204 of FIG. 2 illustrating a predefined market linkage in textile sectors according to an embodiment herein. The table view 300A includes an agriculture industry field 302A, a ginning/spinning industry field 304A, a handloom/power loom industry 306A, and traders/whole sellers/retailers field 308A. The connections suggestion module 204 suggests connections based on the predefined market linkage. For example, the agriculture industry may be backward linkage to ginning industry/spinning industry vice versa the ginning industry/spinning industry may be the forward linkage for the agriculture industry. Here the agriculture industry supplying “raw cotton” to the ginning industry/spinning industry. Similarly, the ginning industry/spinning industry is a backward linkage for handloom/power loom industry. Here the handloom/power loom industry is buying “Yarn” from the ginning industry/spinning industry. Similarly, the handloom/power loom industry may be forward linkage to the traders\Whole sellers/Retailers. Here the handloom/power loom industry is supplying “apparels, Made-ups” to the traders\Whole sellers/Retailers.

FIG. 3B is a flow diagram that illustrates industry category based suggesting connection among business entities according to an embodiment herein. In step 302B, it is checked, business entity A belongs to which industry type based on the collected industry master data. In step 304B, the business entity A is identified as handloom industry type based on the collected master data. In one embodiment, the handloom industry is considered as an example. In step 306B, one or more buyer industries for handloom is checked based on the collected master data. In step 308B, consumers, hotel may be identified as a forward linkage for handloom. In step 310B, one or more business entities of industry type are searched for consumer, hotel from the collected information. In step 312B, business entity C and business partner Y may be identified from the collected master data. In step 314B, business entity C and business partner Y may be suggested connections as buyers. In step 316B, one or more supplier industries for Handloom are checked, once business entity A is identified as Handloom industry type in step 304B based on the collected master data. In step 318B, agricultural-marketing, chemicals may be identified as a backward linkage for handloom. In step 320B, one or more business entities of industry type for consumer, hotel may be searched from the collected master data. In step 322B, business entity B and business partner X may be identified. In step 324B, business entity B and business partner X may be suggested connections as suppliers.

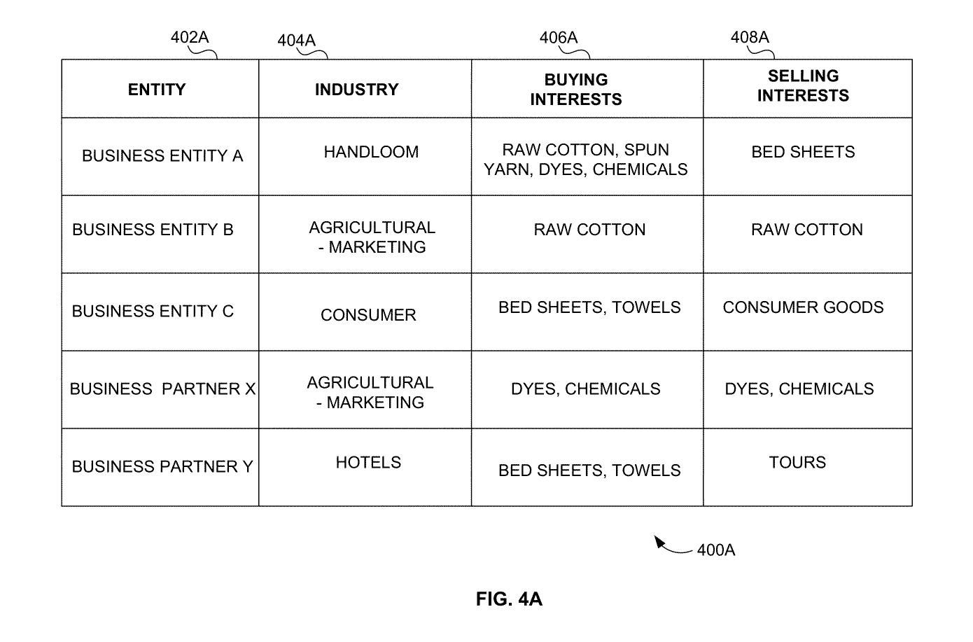

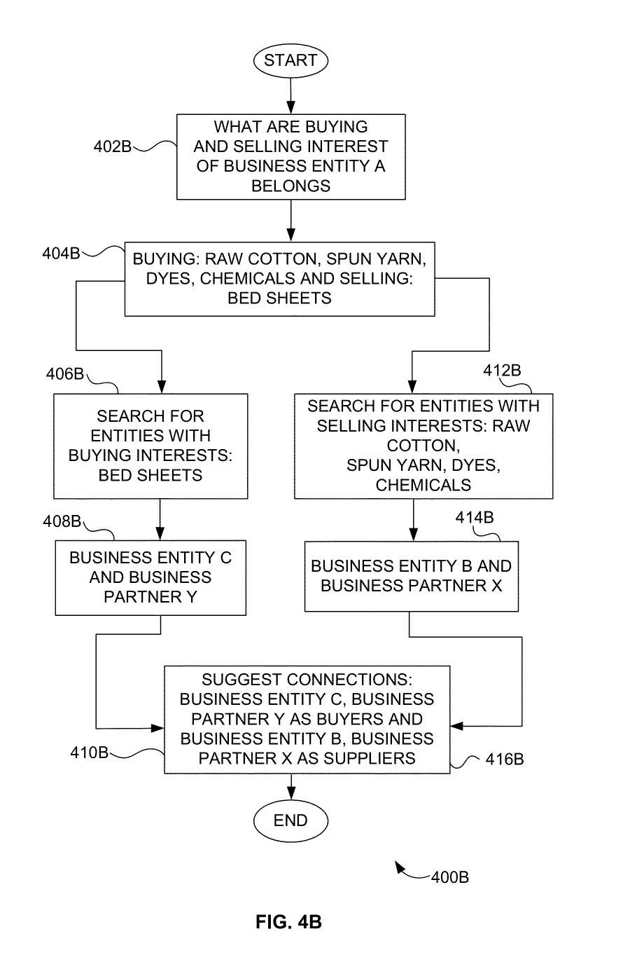

FIG. 4A is a table view of the connections suggestion module 204 of FIG. 2 illustrating one or more suggested connections among business entities based on a product based category according to an embodiment herein. The table view 400B includes an entity field 402A, an industry field 404A, a buying interests field 406A, and a selling interest field 408A. For example as shown in FIG. 4A, the business entity A belongs to ‘Handloom’ industry may search business entity or business partners with industries that can either be a buyer industry or supplier industry to ‘Handloom’. The connections suggestion module 204 may suggest business entity B and business partner X as supplier connection since they belongs to ‘Agricultural-Marketing’ industry and this industry is listed as probable supplier industry for ‘Handloom’. Similarly, the connections suggestion module 204 may suggest business entity C and Business Partner Y as probable buyer connection.

FIG. 4B is a flow diagram that illustrates product category based suggesting connection among business entities according to an embodiment herein. In step 402B, business entity A is checked for buying and selling interests based on the collected master data. In step 404B, buying interests may be identified as raw cotton, spun yarn, dyes, chemicals and selling interests may be identified as bed sheets. In step 406B, business entities are searched as buying interests for bed sheets. In step 408B, business entity C and business partner Y may be identified as buyers. In step 410B, business entity C, business partner Y may be suggested connections as buyers. In step 412B, one or more business entities may be searched with selling interests as raw cotton, spun yarn, dyes, and chemicals. In step 414B, business entity B and business partner X may be identified as suppliers based on the collected master data. In step 416B, business entity B, business partner X may be suggested connections as suppliers.

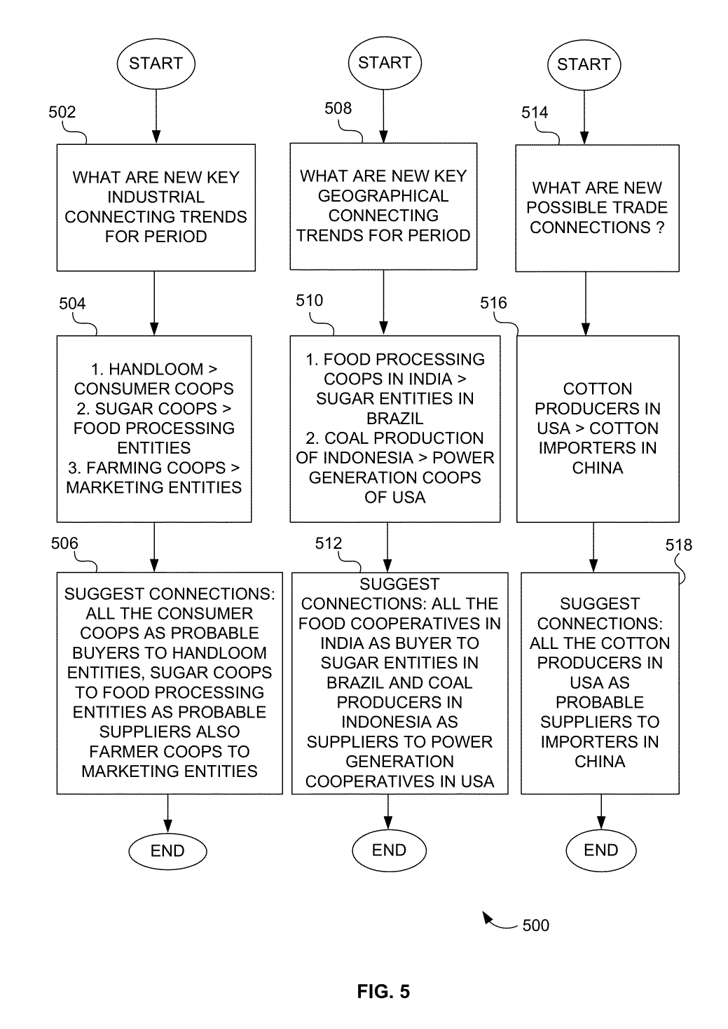

FIG. 5 is a flow diagram that illustrates analytics based suggested connections among business entities according to an embodiment herein. In step 502, it is checked for what may be the new industrial connecting trends based on the collected master data and analyzed report. In step 504, (a) handloom entities connecting with consumer cooperatives (b) sugar cooperatives connecting with the food processing entities and (c) farming cooperatives connecting with the marketing entities may be identified. In step 506, connections may be suggested as all the (a) consumer cooperatives as probable buyers to handloom entities, (b) sugar cooperatives to food processing entities as probable suppliers.

In step 508, it is checked for what may be the new geographical connecting trends based on the collected master data and analyzed report by the analytics module 202. In step 510, (a) food processing cooperatives in India connecting with sugar entities in Brazil (b) coal production of Indonesia connecting with power generation cooperatives of USA may be identified. In step 512, connections may be suggested as all the food cooperatives in India as buyer to sugar entities in Brazil and coal producers in Indonesia as suppliers to power generation cooperatives in USA. In step 514, it is checked for what may be the new possible trade connections based on the collected master data and analyzed report by the analytics module 202. In step 516, cotton producers in USA connecting with Chinese cotton importers may be identified. In step 518, connections may be suggested as all the US cotton producers as probable suppliers to Chinese importers.

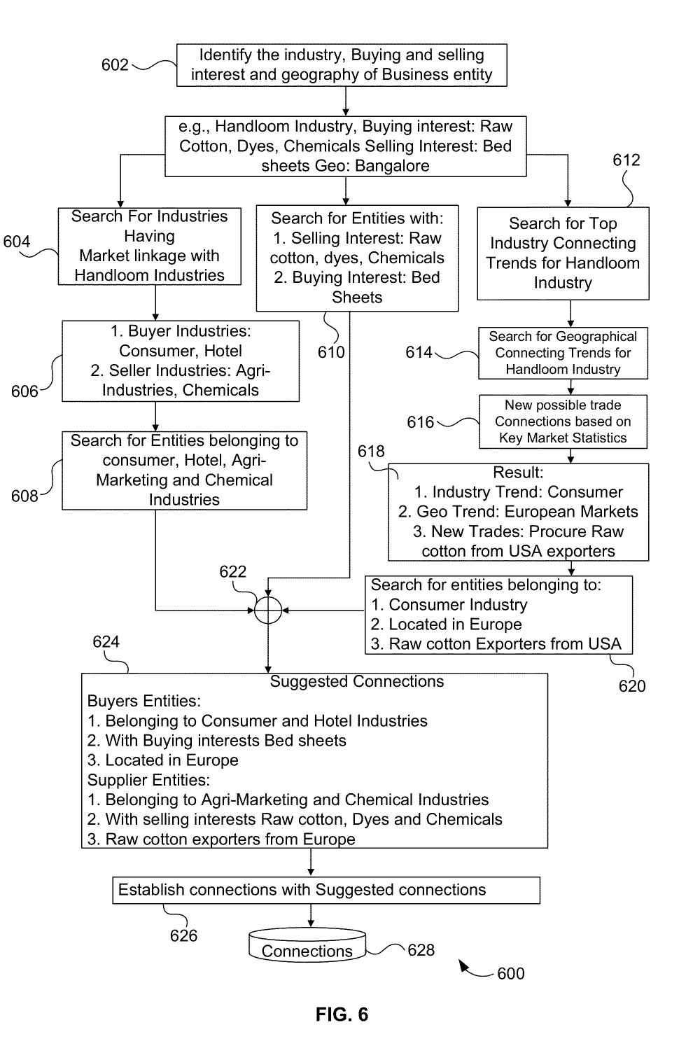

FIG. 6 is a flow diagram illustrating a method of suggesting connections among business entities according to an embodiment herein. In step 602, industry type (e.g., Handloom Industry), buying interest (e.g., Raw Cotton, Dyes, and Chemicals), selling interest (e.g., Bed sheets) and geography (e.g., Bangalore) of business entity are identified based on the collected master data. In step 604, industries having market linkage with handloom industries are searched. In step 606, industries having market linkage with handloom industries may be identified (e.g., 1. buyer industries: consumer, hotel 2. Seller industries: Agri-industries, chemicals). In step 608, business entities belonging to consumer, hotel, Agri-marketing and chemical industries are searched. Similarly, in step 610, entities are searched based on 1. Selling interest: raw cotton, dyes, chemicals 2. Buying interest: bed sheets. In step 612, top industry connecting trends for handloom industry are searched. In step 614, search for geographical connecting trends for handloom industry based on the collected master data. In step 616, search new possible trade connections based on key market statistics. In step 618, the result for above process steps 612-616 may be identified as 1. Industry trend: consumer, 2. Geo trend: European markets, and 3. New trades: Procure raw cotton from us exporters. In step 620, the entities belonging to 1. Consumer Industry, 2. Located in Europe and 3. Raw cotton Exporters from US is searched. In step 622, all the steps from 604-620 are correlated for suggesting probable connections among the business entities. In step 624, suggested connections are identified as Buyers Entities: 1. Belonging to Consumer and Hotel Industries, 2. With Buying interests Bed sheets, and 3. Located in Europe. Supplier Entities: 1. Belonging to Agri-Marketing and Chemical Industries, 2. With selling interests Raw cotton, Dyes and Chemicals and 3. Raw cotton exporters from Europe. In step 626, connections may be established among the business entities based on the suggested connections.

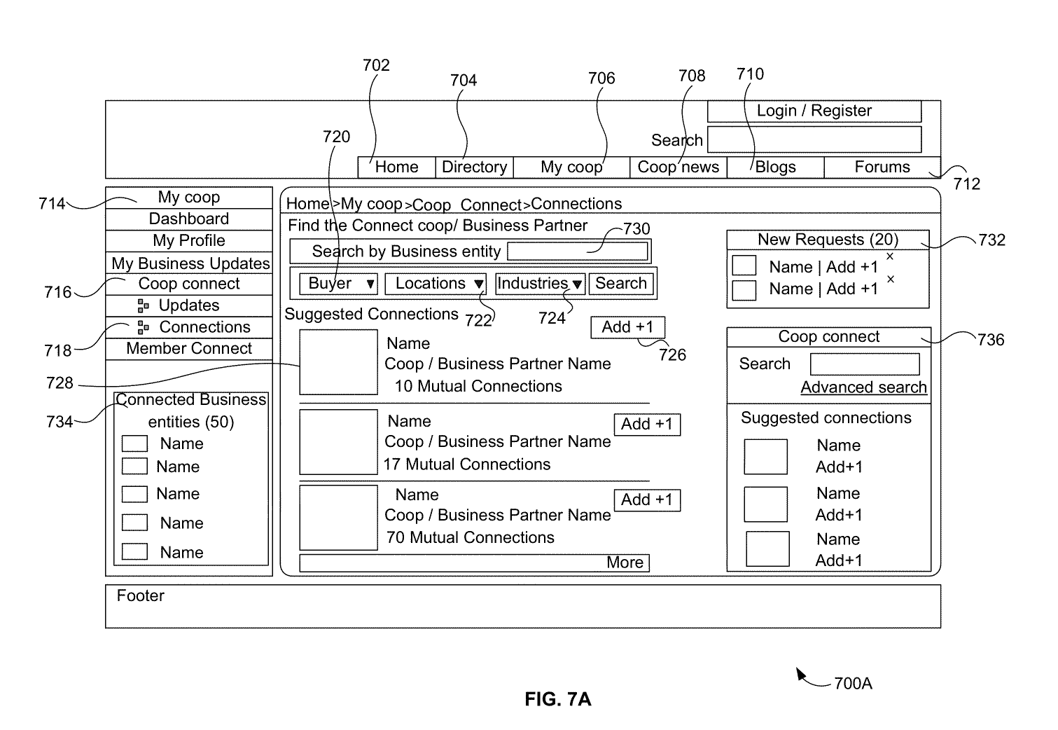

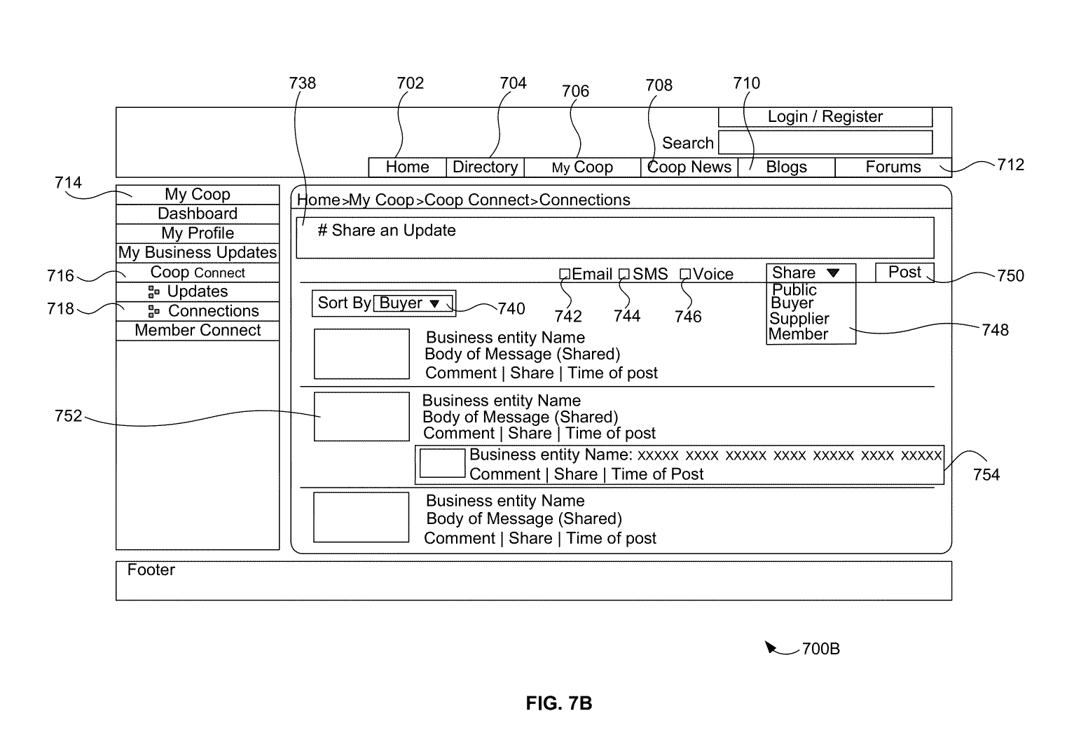

FIG. 7A is a user interface view of the adaptive collaboration system 102 of FIG. 1 illustrating suggesting connections among business entities according to an embodiment herein. The user interface view 700A includes a my coop field 706, a coop news field 708, a blogs field 710, a forums field 712, a my coops field 714, a coop connect field 716, a connections field 718, a buyer field 720, a locations field 722, a industries field 724, a Add field 726, a suggested connections field 728, a search by coop field 730, a new requests field 732, a connected coops field 734, and a business entity connect field 736. The user interface view 700A allows suggesting one or more probable connections by advance search functionality and manages the connections among the business entities. The suggested connection field 728 highlights the available list of probable connections among the business entities. In one embodiment, the connections are suggested based on industry, buyer/supplier interests, and geography.

FIG. 7B is a user interface view of the adaptive collaboration system 102 of FIG. 1 illustrating sharing updates among business entities according to an embodiment herein. The user interface view 700B includes a share an update field 738, a sort by field 740, an email field 742, a SMS field 744, a voice field 746, a share field 748, a post field 750, a coop name field 752, and a body of message field 754. The share an update field 738 allows sharing updates among the business entities on the network of business entities 110. In another embodiment, updates may be business updates, business promotions, buying requirements and general information updates. In one embodiment, sharing update may be to specific business entities or business partners. The share field 748 allows sharing update to specific business entities or other connected business entities (e.g., public, buyer, supplier, and/or members).

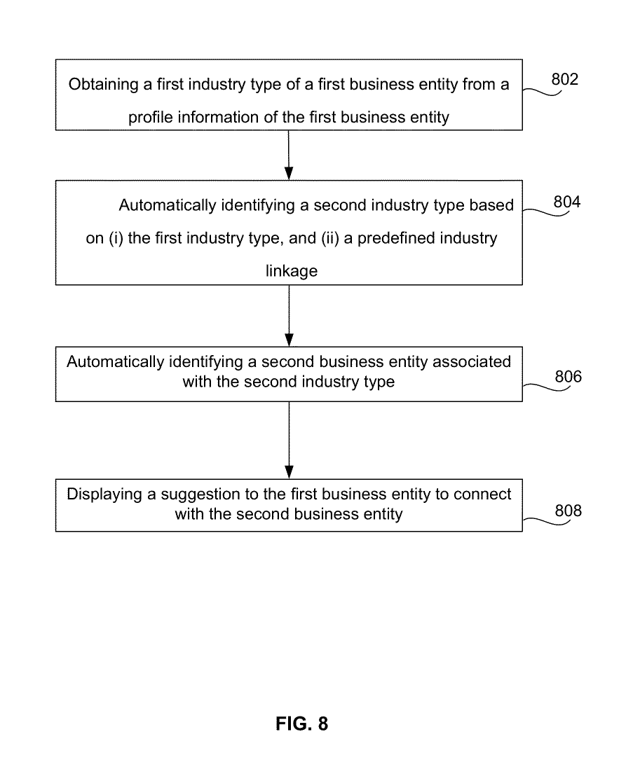

FIG. 8 is a flow diagram illustrates a method of suggesting connections among business entities on a network of business entities according to an embodiment herein. In step 802, a first industry type of a first business entity is obtained from profile information of the first business entity. In step 804, a second industry type is automatically identified based on one or more (i) a first industry type, and (ii) a predefined industry linkage. In step 806, a second business entity associated with the second industry type is automatically identified. In one embodiment, the predefined industry linkage may include a forward linkage or a backward linkage between the first industry type and the second industry type. In step 808, a suggestion to the first business entity to connect with the second business entity is displayed.

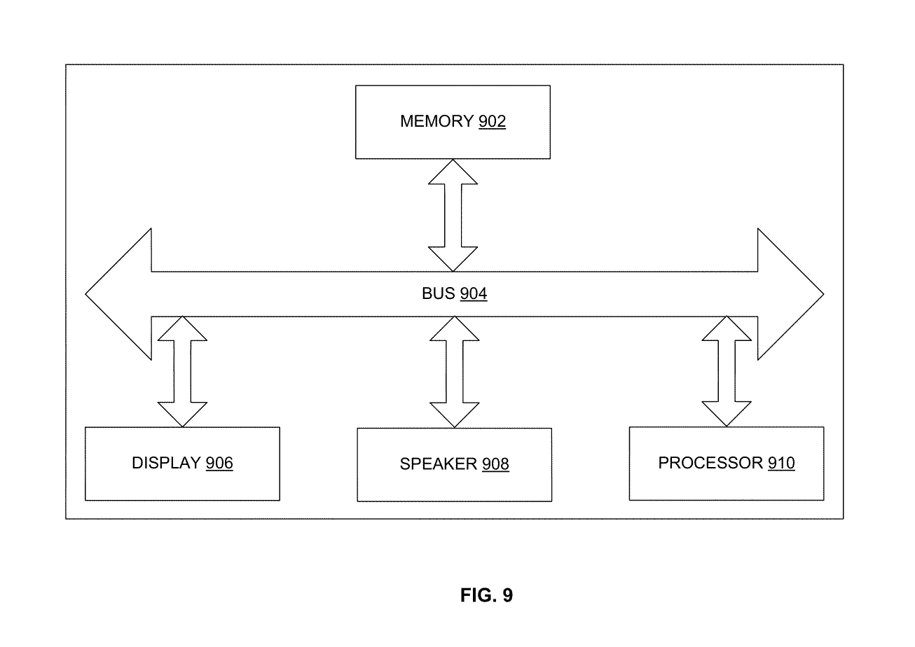

FIG. 9 illustrates an exploded view of the personal communication device 112A-C having an a memory 902 having a set of computer instructions, a bus 904, a display 906, a speaker 908, and a processor 910 capable of processing a set of instructions to perform any one or more of the methodologies herein, according to an embodiment herein. In one embodiment, the receiver may be the personal communication device. The processor 910 may also enable digital content to be consumed in the form of video for output via one or more displays 906 or audio for output via speaker and/or earphones 908. The processor 910 may also carry out the methods described herein and in accordance with the embodiments herein.

Digital content may also be stored in the memory 902 for future processing or consumption. The memory 902 may also store program specific information and/or service information (PSI/SI), including information about digital content (e.g., the detected information bits) available in the future or stored from the past. A user of the personal communication device 112A-C may view this stored information on display 906 and select an item of for viewing, listening, or other uses via input, which may take the form of keypad, scroll, or other input device(s) or combinations thereof. When digital content is selected, the processor 910 may pass information. The content and PSI/SI may be passed among functions within the personal communication device 112A-C using the bus 904.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

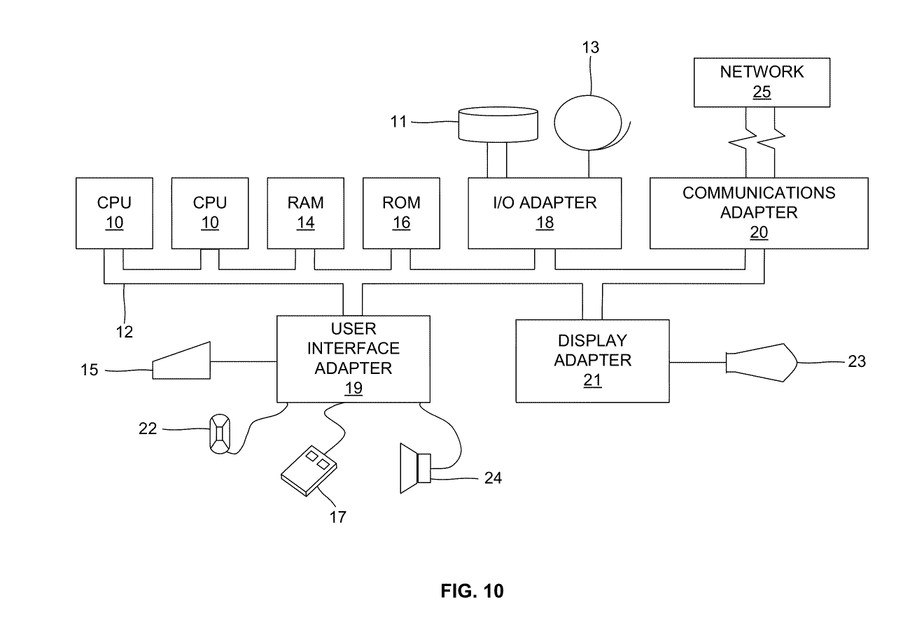

A representative hardware environment for practicing the embodiments herein is depicted in FIG. 10. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The adaptive collaboration system 102 provides localized content and access to information on-demand (based on subscription) to the members and other connected business entities, and enables effective management of member relationships. The adaptive collaboration system 102 helps to discover the synergies for enabling and to facilitate better collaboration among business entities.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method for suggesting to a first business entity to connect with a second business entity on a network of business entities, said method comprising:
(i) obtaining a first industry type of said first business entity from a profile information of said first business entity;
(ii) automatically identifying a second industry type based on (i) said first industry type, and (ii) a predefined industry linkage;
(iii) automatically identifying said second business entity associated with said second industry type; and
(iv) displaying a suggestion to said first business entity to connect with said second business entity.

2. The method of claim 1, wherein said predefined industry linkage comprises a forward linkage or a backward linkage between said first industry type and said second industry type.

3. The method of claim 1, further comprising, automatically identifying a third industry type based on said predefined industry linkage.

4. The method of claim 1, further comprising, (a) automatically obtaining a buying interest of said first business entity based on said profile information of said first business entity, and (b) identifying a third business entity associated with a matching selling interest that matches with said buying interest of said first business entity.

5. The method of claim 1, further comprising, (a) automatically obtaining a selling interest of said first business entity based on said profile information of said first business entity, and (b) identifying a fourth business entity associated with a matching buying interest that matches with said selling interest of said first business entity.

6. The method of claim 1, further comprising, collaborating among said first business entity and said second business entity on said network of business entities.

7. The method of claim 6, further comprising, sharing updates on said first business entity with said second business entity on said network of business entities, wherein said updates comprises at least one of (i) a business activity, (ii) a business promotion, (iii) a buying requirement and (iv) a general information update.

8. The method of claim 1, further comprising, identifying at least one of (a) an industrial connecting trend across business entities that are associated with said first industry type of said first business entity, (b) a geographical connecting trend across business entities that are located at a geography of said first business entity, and (c) a trade connection trend among business entities across geographies, wherein said trade connection among said geographies are obtained based on market statistics.

9. A system for enabling connections among business entities, comprising:
(a) a memory unit that stores (i) a set of modules, and (ii) a database;
(b) a display unit;
(c) a processor that executes said set of modules, wherein said set of modules comprises:
(i) an industry type obtaining module, executed by said processor, that obtains a first industry type of a first business entity from a profile information of said first business entity;
(ii) an industrial connecting trend module, executed by said processor, that obtains an industrial connecting trend across business entities that are associated with said first industry type of said first business entity;
(iii) a geographical connecting trend module, executed by said processor, that obtains a geographical connecting trend across business entities that are located at a geography of said first business entity;
(iv) a trade connection trend module, executed by said processor, that identifies a trade connection trend among business entities across geographies, wherein said trade connection trend among geographies is obtained based on market statistics; and
(v) a connections suggestion module, executed by said processor, that suggests to said first business entity to connect with a second business entity based on (a) said industrial connecting trend, (b) said geographical connecting trend, and (c) said trade connection trend.

10. The system of claim 9, wherein said industry type obtaining module, executed by said processor, that identifies at least one of:
(a) a second industry type based on at least one of (i) said first industry type, and (ii) a predefined industry linkage; and
(b) a third industry type based on said predefined industry linkage.

11. The system of claim 9, wherein said predefined industry linkage comprises a forward linkage or a backward linkage between said first industry type and said second industry type.

12. The system of claim 9, wherein a buying interest of said first business entity is automatically obtained based on said profile information of said first business entity.

13. The system of claim 12, wherein a third business entity associated with a matching selling interest is identified that matches with said buying interest of said first business entity.

14. The system of claim 9, wherein a selling interest of said first business entity is automatically obtained based on said profile information of said first business entity.

15. The system of claim 14, wherein a fourth business entity associated with a matching buying interest is identified that matches with said selling interest of said first business entity.

16. The system of claim 9, further comprises, an updates sharing module, executed by said processor, that share updates on said first business entity with said second business entity, wherein said updates comprises at least one of (i) a business activity, (ii) a business promotion, (iii) a buying requirement and (iv) a general information update.

17. The system of claim 9, further comprises, a macro economic indicator module, executed by said processor, which identify a business connection based on said market statistics.

18. A method for suggesting to a first business entity to connect with a second business entity on a network of business entities, said method comprising:
(i) obtaining a first industry type of said first business entity from a profile information of said first business entity;
(ii) obtaining a buying interest and a selling interest of said first business entity from a profile information of said first business entity;
(iii) obtaining an industrial connecting trend across business entities that are associated with said first industry type of said first business entity;
(iv) obtaining a geographical connecting trend across business entities that are located at a geography of said first business entity;
(v) obtaining a trade connections trend among business entities across geographies that are associated with said first business entity, wherein said trade connections trend is obtained based on key market statistics;
(vi) automatically identifying a second industry type based on (i) said first industry type, (ii) a predefined industry linkage, (iii) said industrial connecting trend, (iv) said geographical connecting trend, and (v) said trade connections trend;
(vii) automatically identifying said second business entity associated with said second industry type;
(viii) identifying a third business entity associated with a matching selling interest that matches with said buying interest of said first business entity;
(ix) identifying a fourth business entity associated with a matching buying interest that matches with said selling interest of said first business entity; and
(x) displaying a suggestion to said first business entity to connect with said second business entity.

19. The method of claim 18, wherein said predefined industry linkage comprises a forward linkage or a backward linkage between said first industry type and said second industry type.

20. The method of claim 18, further comprising, sharing updates among said first business entity and said second business entity on said network of business entities, wherein said updates comprises at least one of (i) a business activity, (ii) a business promotion, (iii) a buying requirement and (iv) a general information update.
